(19) United States
(12) Patent Application Publication
(10) Pub. No.: US 2007/0027808 A1
(43) Pub. Date: Feb. 1, 2007

(54) Strategies for queuing events for subsequent processing

(75) Inventors: James H. Dooley IV, Bellevue, WA (US); Jason S. Flaks, Bellevue, WA (US); Mukul Gupta, Redmond, WA (US); Sean D. Kelly, Redmond, WA (US); Charles Alan Ludwig, Renton, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/192,510

(22) Filed: Jul. 29, 2005

(51) Int. Cl. G06Q 99/00

(52) U.S. Cl. 705/51

(57) ABSTRACT

In one exemplary implementation, strategies are described which transmit notification information from a first device (e.g., a media server) to a second device (e.g., a remote media device). Based on this notification information, a recipient-user can use the first device to generate an event pertaining to the notification information and forward the event to the second device, where the event is logged. The second device can then send prompting information to a follow-up user (who may be the same as the recipient-user) to alert that user to the existence of the logged event. The follow-up user can further advance an action (such as buying a resource, printing a resource, and so forth) based on the prompting information. Filtering mechanisms are described for determining which recipient-users are able to send events, and for determining which follow-up users are able to receive prompting information that indicates the existence of events.

### BACKGROUND

The industry has provided a number of technologies for coupling devices together in a seamless manner. Universal Plug and Play (UPnP) is one such technology. Universal Plug and Play (UPnP) provides functionality that facilitates adding and removing devices from a UPnP-equipped network. For instance, UPnP technology allows a user to simply “plug” a new device into a network coupling; thereafter, the UPnP network will automatically determine the new device's characteristics and subsequently coordinate interaction between this new device and other devices in the network based on the determined characteristics. UPnP technology is particularly well suited for networks associated with a local setting, such as a home, a business, a school, etc.

A so-called UPnP device conceptually defines an abstract container that can include actual devices, services, etc. One such UPnP device is a media server; another is a media rendering device. The media server supplies content information to one or more media rendering devices, as controlled by one or more control point entities. Exemplary media servers can include various types of computers, jukeboxes, personal video recorders, and so on. Exemplary media rendering devices can include various types of computers, stereo systems, TVs, hand-held audio players, and so on. A control point can be integrated with one of the above-identified UPnP devices. For instance, a media rendering device can also include control point functionality for interacting with a media server. Alternatively, a control point can represent a device that is implemented separate from a media rendering device that actually presents the media information. The UPnP Forum's web site (i.e., http://upnp.org/) provides more detailed background information regarding the UPnP architecture and related topics.

Technologies such as UPnP thereby facilitate the uniform integration of a number of electronic devices within a household or within some other defined environment. However, there exists room for improvement in these types of technologies.

For instance, consider the case in which a user is operating a media rendering device (such as a television set) to play media information supplied by a media server. As appreciated by the present inventors, the user might want to take some action in response to the media presentation. For example, assume that the user is watching a commercial and wishes to purchase a resource being advertised by the commercial. To conventionally perform this task, the user is required to manually make a note of contact information provided in the commercial (or commit this information to memory) and then manually use this information to complete the transaction at a later point in time. For instance, the user might use the manually recorded or memorized contact information to place a telephone call or access a website in order to complete the transaction. A similar procedure can be used to perform other types of transactions. For instance, the user might be browsing through photographs on a remote media device and wish to print out one or more photographs of particular interest to the user. To perform this task, the user needs to make a note of which photographs should be printed (or commit this information to memory). The user can then manually access the source of these photographs (e.g., a personal computer) to print the identified photographs out.

The above procedure is cumbersome. As a result, the user may decline to go through the trouble of carrying out the transaction. The above procedure is also potentially error-prone. For instance, the user may inaccurately write down (or memorize) a telephone number or website address in response to a commercial. Both of these drawbacks can result in a poor experience for the user when performing transactions. Further, these drawbacks may negatively impact the entity which provides the equipment or services used to perform these transactions, e.g., as a result of the user's reluctance to perform transactions.

Accordingly, there is an exemplary need for more effective techniques for integrating devices together to perform any kind of transaction.

### SUMMARY

Strategies are described herein for handling a transaction, part of which is performed using a first device, and the other part of which is performed using a second device. In one exemplary and non-limiting case, the first device is a remote media device and the second device is a media server. In this exemplary implementation, the media server sends notification information to a recipient-user for presentation at the remote media device. The notification information may solicit a response from the recipient-user to perform some commencement action, such as initiate the purchase of a resource, print out a resource, and so forth. The recipient-user can perform the commencement action by actuating a physical control or a user interface (UI) control provided by the remote media device (or provided by another device, such as a remote control device). This action creates an event which describes the commencement action. The event can include two parts: a first part describes a target object of the recipient-user's action (such as the resource that the recipient-user wishes to purchase); and a second part describes the action which the recipient-user wishes to perform on the object (namely, in one case, to purchase the resource). The media server receives the event and logs the event in association with the recipient-user who generated the event.

Next, assume that the recipient-user, or perhaps another user, later directly interacts with the media server. (The user of the media server is generically referred to as a “follow-up user” herein to indicate that the user takes action after the recipient-user creates the event.) This causes the media server to provide visual and/or audio prompting information which alerts the follow-up user to the existence of the event. If the follow-up user activates the prompting information, then the media server can coordinate the presentation of an interface which allows the follow-up user to further advance the transaction that was started by the recipient-user at the remote media device. For example, the follow-up user can purchase a resource flagged by a buy-event received from the recipient-user.

One benefit of this approach is that the recipient-user can conveniently tag resources concerning which some action is desired. Then the follow-up user (who may represent the same user as the recipient-user) can be conveniently apprised of the flagged resources and given the opportunity to complete the transaction pertaining to the resources. This reduces the need for the recipient-user to manually record or memorize the details of a transaction in order to continue with the transaction using another device.

According to another advantage, the remote media device is often (although not necessarily) a device with limited processing capabilities. Therefore, this device may not have the functionality to adequately handle all aspects of a transaction. The strategies described herein, however, effectively leverage this limited processing capability by piggybacking this capability onto the enhanced functionality provided by the media server. That is, the remote media device can at least inform the media server of an event, and thereby commence a transaction; the media server can then complete the transaction using its enhanced functionality. This allows the remote media device to remain relatively simple, yet still enable the user to perform complex actions.

A number of other features contribute to the usefulness of the strategies. For example, a mechanism can be employed which limits the propagation of notification information to the recipient-user. Namely, in one implementation, the media server only sends notification information to those recipient-users (and associated media rendering devices) that are pre-authorized to receive such information. Or the media server can send the notification information to many users, but only allow pre-authorized users to respond to the notification information. Likewise, the media server can restrict the dissemination of prompting information to only authorized follow-up users. The media server provides this prompting information to a follow-up user when the event is first received by the media server (if the follow-up user is able to receive this information), or when the follow-up user resumes an active session with the media server after having been inactive for some time.

Additional implementations can apply the above-described approach to other scenarios. In one such alternative scenario, the first device can perform an action with respect to a local resource (such as a file in a first data store), and then create an event for transmission to the second device. The second device can act on the event by making changes to a counterpart resource stored in its own local data store (comprising a second data store). In this case, the follow-up action can be said to “complete” the commencement action in these sense that it duplicates the commencement action (which was performed at the first device) on the second device as well. Still other applications of the above-described event processing paradigm are possible.

Still further features and attendant benefits of the strategies will be set forth below.

The subject matter set forth in this Summary section refers to exemplary manifestations of the invention, and hence does not limit the scope of the invention set in the Claims section. More specifically, the Claims section may set forth aspects of the invention which are broader in scope than the concepts described in this Summary section.

### BRIEF DESCRIPTION OF THE DRAWINGS

FIG. 1 shows an exemplary system for handling a transaction in two parts, a first of which a recipient-user performs by interacting with a remote media device, and a second of which a follow-up user performs by interacting with a media server.

FIG. 2 shows a depiction of an exemplary event handling module implemented by the media server of FIG. 1.

FIG. 3 shows an exemplary remote media device for use in the system of FIG. 1.

FIG. 4 shows exemplary prompting information displayed by the media server of FIG. 1.

FIG. 5 shows an exemplary user interface presentation that the media server can present when the user actives the prompting information of FIG. 4.

FIG. 6 shows another exemplary user interface presentation that the media server can present when the user activates the prompting information of FIG. 4.

FIG. 7 shows an exemplary markup language module which can implement a protocol for exchanging event information in the system of FIG. 1.

FIGS. 8-10 together show exemplary aspects of the manner of operation of the system shown in FIG. 1.

FIG. 11 shows an alternative application of the use of events to handle a transaction.

FIG. 12 shows an exemplary computer environment for implementing aspects of the systems of any of the preceding figures.

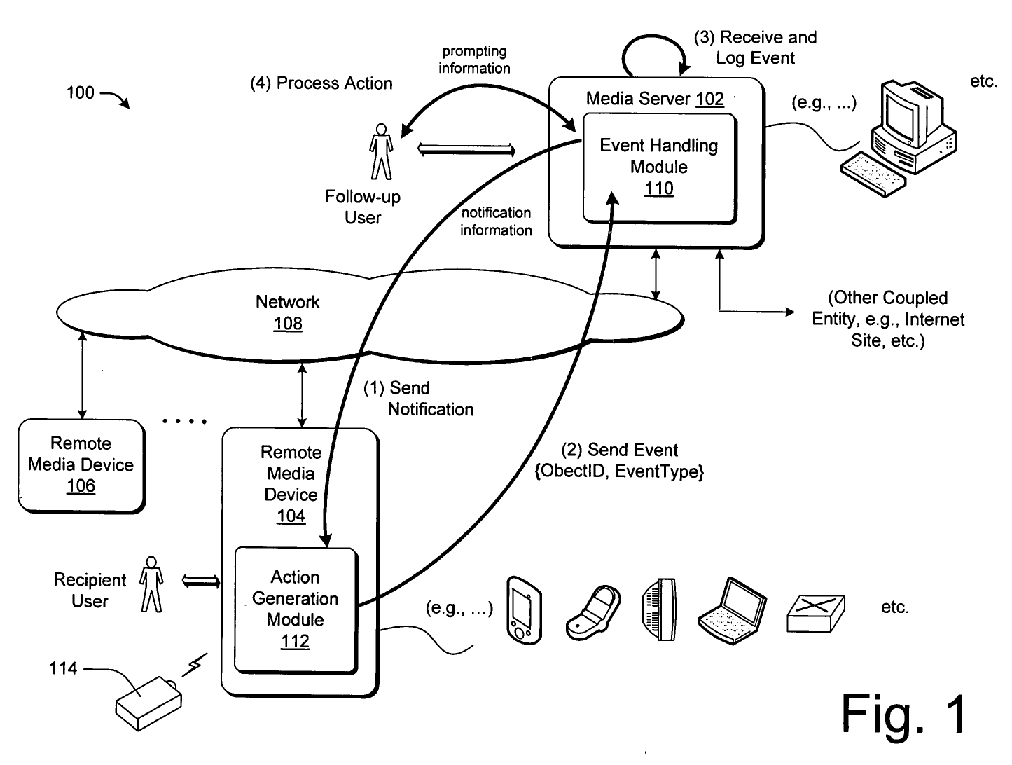

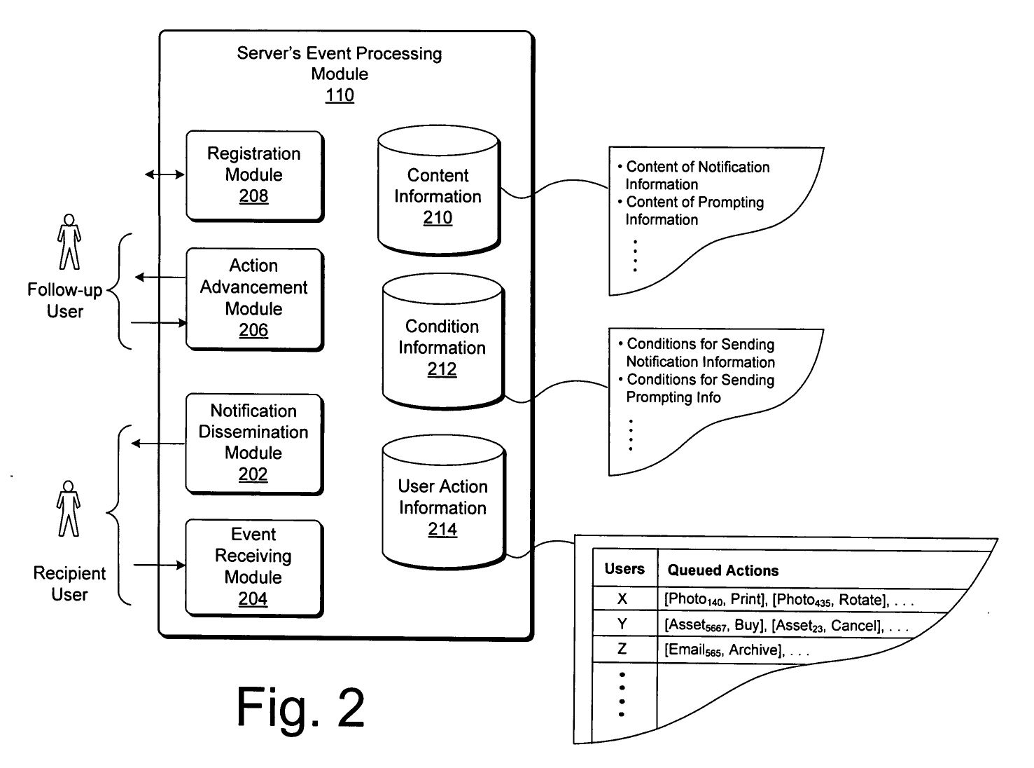

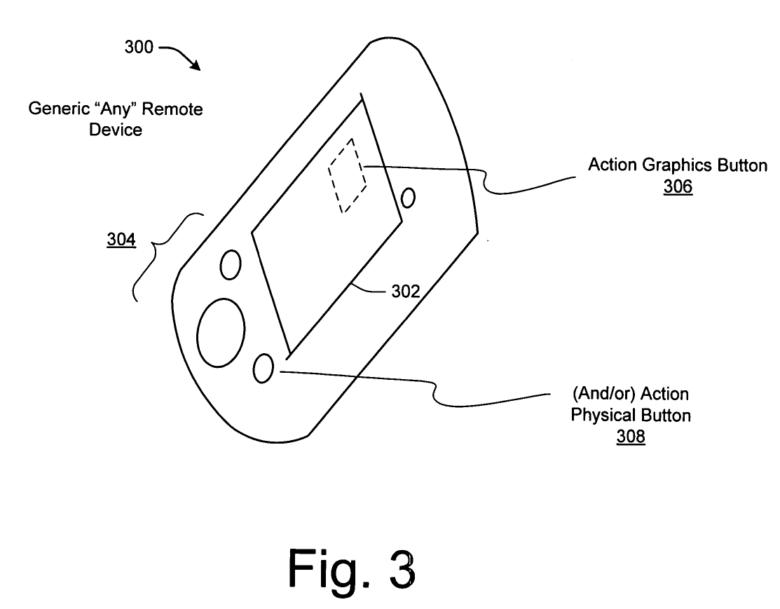

The same numbers are used throughout the disclosure and figures to reference like components and features. Series 100 numbers refer to features originally found in FIG. 1, series 200 numbers refer to features originally found in FIG. 2, series 300 numbers refer to features originally found in FIG. 3, and so on.

### DETAILED DESCRIPTION

In brief, the strategies provide a seamless and convenient technique for creating an event using a remote media device, thereby commencing a transaction. The technique then hands off this event to the media server for the completion the transaction.

As a preliminary matter, certain terms used in this description are defined below:

The term “resource” refers to any identifiable asset. The asset can refer to information (such as media information), a tangible article, a service, and so on.

The term “recipient-user” refers to a user (or automated agent) which interacts with any kind of device to create a commencement action. This operation creates an event.

The term “event” refers to any information which describes an action taken by the recipient-user.

The term “follow-up user” refers to a user (or automated agent) which interacts with any kind of device to process an event created by the recipient-user. The recipient-user may be the same as or different than the follow-up user.

The term “commencement action” refers to any kind of action taken by the recipient-user to initiate a transaction. For example, the commencement action might comprise an instruction to initiate the purchase of a resource.

The term “follow-up action” refers to any kind of action taken by the follow-up user to complete (or to at least further process) a transaction, initiated by the commencement action. The “follow-up action” may represent a final consummating step in a transaction or only a further advancement of the transaction.

The term “notification information” refers to any kind of information sent to the recipient-user that entices the recipient-user to perform the commencement action. The notification information might describe, for instance, a resource that can be purchased.

The term “prompting information” refers to any kind of information sent to the follow-up user to alert this user to the existence of an event created by the recipient-user.

More generally, certain examples developed herein rely on Universal Plug and Play (UPnP) technology to coordinate the interaction between a media server and a remote media device. However, the principles described herein are not limited to UPnP technology.

Moreover, certain examples developed herein discuss the queuing of events in a home environment, e.g., where a recipient-user uses a remote media device to perform a commencement action within the home, and then later uses a media server (e.g., a personal computer), also within the home, to complete the transaction. However, the principles described herein can be applied to any environment, including other kinds of local environments (such as business-related environments), as well as applications that are not considered “local” in nature. For example, the remote media device and the media server can be coupled together using a wide area network, e.g., using Web Services technology or the like.

Further, certain examples developed herein discuss the commencement action and the follow-up action in terms of a procedure performed by human users in response to receiving information which induces the users to perform actions. But the principles described herein can also apply to partially or fully automated systems, e.g., in which a first device automatically sends an event to a second device in response to some kind of triggering occurrence, and/or in which the second device automatically acts on the event upon receipt.

Further, certain examples developed herein describe the commencement action as having no transformative effect with respect to the first device (which generates the event). But in other cases, the commencement action can represent an action which achieves a transformative result at the first device, and the follow-up action achieves a transformative result at the second device. This is case for a resource synchronization application, in which the commencement action produces a change in at least one resource in a first data store, and the follow-up action produces the same change in at least one counterpart (e.g., duplicate) resource in a second data store.

Still other variations are encompassed by the following discussion.

This disclosure includes the following sections. Section A presents an exemplary system for implementing the principles described herein. Section B describes an exemplary method of operation of the system of Section A. Section C describes an alternative exemplary system for implementing the principles described herein. And Section D describes an exemplary computer environment for implementing aspects of the systems of the preceding sections.

A. Exemplary System

Generally, any of the functions described with reference to the figures can be implemented using software, firmware (e.g., fixed logic circuitry), manual processing, or a combination of these implementations. The term “logic, “module” or “functionality” as used herein generally represents software, firmware, or a combination of software and firmware. For instance, in the case of a software implementation, the term “logic,” “module,” or “functionality” represents program code (or declarative content) that performs specified tasks when executed on a processing device or devices (e.g., CPU or CPUs). The program code can be stored in one or more computer readable memory devices. More generally, the illustrated separation of logic, modules and functionality into distinct units may reflect an actual physical grouping and allocation of such software and/or hardware, or can correspond to a conceptual allocation of different tasks performed by a single software program and/or hardware unit. The illustrated logic, modules and functionality can be located at a single site (e.g., as implemented by a processing device), or can be distributed over plural locations.

FIG. 1 shows an exemplary system 100 for queuing events and then further advancing the transactions based on those queued events. The exchange of information between the components shown in FIG. 1 can be governed by any technology, such as, but not limited to, Universal Plug and Play (UPnP) technology.

The system includes a collection of devices, including a media server 102, and one or more remote media devices (104, . . . 106). The devices (102, 104, . . . 106) are coupled together via a network 108. A “recipient-user” interacts with the representative remote media device 104, while a “follow-up user” interacts with the media server 102. As explained above, the recipient-user may represent the same individual as the follow-up user, or may represent a different individual. Or the “users” may pertain to automated agents (e.g., logic functionality) which automatically perform the roles of individuals.

In one basic UPnP flow of operations, the media server 102 forwards information to one or more remote media devices (104, . . . 106). One of more control points orchestrate the exchange of information among the components shown in FIG. 1. In one case, a control point can be integrated with any of the components shown in FIG. 1 (such as one of the remote media devices). For example, the media server 102 can pass information to the remote media device 104, which renders the information. Here, the remote media device 104 can act as both a media rendering device and also a control point. In another case, the control point can represent a separate entity. For example, the media server 102 can pass information under the direction of the remote media device 104 to another remote media device, which can then render the information. In this case, the remote media device 104 is functioning in the role of a control point but not as the media rendering device. Still other routing and control paths are possible.

In the system 100, the media server 102 can represent any kind of device with processing capabilities. In a home network case, the media server 102 can be implemented by a personal computer, or other kind of computer. The functionality of the media server 102 which handles events generated by the remote media devices (104, . . . 106) is referred to as an event handling module 110. The event handling module 110 can be implemented in software, hardware, a combination of hardware and software, and so on.

The remote media devices (104, . . . 106) can likewise represent any kind of device. In many cases, although not necessarily, the remote media devices (104, . . . 106) represent devices that have fewer processing resources compared to the media server 102. In other words, the remote media devices (104, . . . 106) may represent “thin devices” (meaning that they have reduced processing resources compared to the media server 102). Exemplary types of remote media devices (104, . . . 106) include any kind of portable or wearable processing device, a mobile telephone device, a set-top box, a game console, an audio playback device, an interactive television, an intelligent appliance, and on. The functionality of the representative remote media device 104 which generates events for transmission to the media sever 102 is referred to as an event generation module 112. The event generation module 112 can be implemented in software, hardware, a combination of hardware and software, and so on.

The recipient-user can interact directly with a remote media device, such as remote media device 104. Or the recipient-user can interact with the remote media device 104 via some other device, such as exemplary remote control device 114. The remote control device 114 may itself comprise a device which is governed by UPnP technology. More specifically, the remote control device 114 can serve the role of a UPnP control point within the system 100.

The network 108 can represent any kind of channel or combination of channels for exchanging information among devices. It can represent a local area network (LAN), a wide area network (WAN), or combination thereof. It can be physically implemented using any kind and combination of links, such as hardwired conductive links, wireless links, power lines, and so forth. The network 108 can also include any combination of network-related equipment, such as various routers, gateways, name servers, and so forth. Any kind of protocol or combination of protocols can be used to exchange information over the network 108, such as TCP/IP, SOAP, GENA, HTTP, and so on.

The bolded arrows shown in FIG. 1 convey an overview of one exemplary manifestation of the event queuing strategy. The queuing strategy is explained in terms of an interaction between the media server 102 and the representative media device 104.

In a first operation (1), the media server 102 sends information to the remote media device 104. This information notifies the recipient-user of some resource concerning which the recipient-user may perform some action, and is thus referred to as “notification information” herein. This term should be broadly construed. In one case, the notification information can include specific instructions which invite the recipient-user to perform some action pertaining to a resource. In another case, the notification information may comprise a presentation of the resource itself, or some sample thereof (such as one track of a music album that may be purchased). In another case, the notification information may comprise some kind of descriptive content associated with the resource (such as a title of an album to be purchased). Descriptive information can also include pictorial content which describes the resource (such as “album art” which provides a picture associated with an album to be purchased). Still other kinds of information may constitute “notification information” as this term is broadly used herein. Further, the notification information can include different combinations of the above-identified kinds of information.

In one case, the media server 102 can send the notification information to a recipient-user in unsolicited fashion (in the manner of random pop-up advertisements). In another case, the media server 102 can send the notification information to a recipient-user that fits into the context of the recipient-user's current interaction with the remote media device 104. For example, the media server 102 can send notification information to the remote media device 104 in response to a request from the recipient-user (such as a browse or search request made by the recipient-user). Still other approaches for sending notification information to the recipient-users are possible.

Consider the specific example of album art. When the recipient-user performs a browse or search operation, the media server 102 can send a response to the remote media device 104 that identifies album art. More specifically, the media server 102 can return the exemplary metadata information:

<AlbumArtURI>http://192.168.0.0/albumart.jpg</AlbumArtURI>.

This metadata information comprises a link which points to album art resources located on the media server 102 (or located elsewhere), and enables the remote media device 104 to access and display the album art. This display operation can be performed in an automatic fashion (if the recipient device is appropriately equipped to display the album art) or can be performed optionally at the discretion of the recipient-user.

More specifically, in one exemplary case, an album art tag can be embedded inside an outer tag which describes a single media resource (such as a single song). In this context, the album art can represent the cover art for the album that includes the song as part of its contents. A single song can have multiple album art tags associated therewith. These multiple tags can present the same album art in different sizes, formats, and so forth, or the tags can possibly represent different albums that include the same song.

Upon receipt of the notification information, the remote media device 104 can present the notification information in any manner, such as by automatically displaying it in a peripheral region of its display, a main region of its display, and so forth. Or the remote media device 104 can display the notification information as a hypertext annotation that can be activated by the recipient-user at their discretion to receive more information, and so forth. Still alternatively (or in addition), the remote media device can audible present the notification information, such as by presenting a message, “If you like this music, why not buy it?”

The media server 102 can selectively send the notification information to only recipient-users who are pre-authorized to act on the information. For example, in a UPnP environment, the system 100 can maintain a database (not shown) which describes the characteristics of the devices in the system 100. The characteristics can be expressed using device profiles. The media server 102 can access this database to determine which devices are pre-authorized to receive the notification information, and then disseminate this information to only those devices that are pre-authorized to receive this notification information. In an alternative case, the media server 102 can send notification information to all remote media devices (104, . . . 106) without restriction, but only enable pre-authorized media devices to perform actions based on this information.

In another scenario, the media server 102 need not send any notification information to the remote media device 104. For example, consider the case in which the recipient-user independently decides that a certain action should be performed on a defined target object. The recipient-user can gratuitously initiate that action at the remote-media device without receiving any kind of prompting information from the media server 102. Or the media server 102 can send notification information to the recipient-user, but the recipient-user can generate the commencement action in delayed fashion after receiving the notification information. This is to say, for instance, that the recipient-user can generate the commencement action without necessarily having the notification information contemporaneously being presented before him or her. In the most general terms, the recipient-user generates the commencement action by having some knowledge about the object which the user is acting on, and this knowledge can be imparted to the user in a great variety of direct and indirect ways.

In a second operation (2), the recipient-user performs some action pertaining to a target object (e.g., comprising a resource identified by the notification information). Because this action initiates a transaction, it is referred to as a “commencement action” herein. A non-exhaustive list of possible commencement actions follows:

A recipient-user can issue an instruction to purchase a particular resource associated with the notification information. For example, the notification information may include pictorial album art which identifies a music album that the recipient-user can purchase, or perhaps a musical excerpt from that album. In response to receiving this notification information, the recipient-user can issue an instruction to purchase that album. The recipient-user can purchase any other kind of resource in a similar manner.

A recipient-user can issue an instruction to cancel a prior purchase request pertaining to an identified resource.

A recipient-user can issue can instruction to create a reservation for a particular resource, such as hotel room, rental car, and so forth.

A recipient-user can issue an instruction to print a particular resource identified by the notification information. For example, the recipient-user might be browsing through a collection of photo images. Upon finding a photo of interest, the recipient-user can issue an instruction to print this photo. In a similar manner, the recipient-user can issue an instruction to forward a resource to an identified target destination. For example, the recipient-user can flag a photo to be sent to her sister, and so forth.

A recipient-user can issue an instruction to perform processing on an identified resource. For example, the recipient-user can issue an instruction to rotate a photo, crop a particular photo, change the coloring and/or brightness of a photo, remove redeye from a photo, and so forth.

A recipient-user can issue an instruction to change the status of an identified resource. For example, consider the scenario in which the recipient-user is browsing through Emails on the remote media device 104. The recipient-user can issue an instruction to archive one of these Emails (to move the Email to long term storage), and so forth.

A recipient-user can issue an instruction to back up an identified resource (e.g., a file) at the media server device 102 (or some other target device).

One skilled in the art will appreciate that there are many more kinds of actions that can be performed, and there are many more kinds of objects that can be the targets of such actions.

The recipient-user can issue an instruction through any kind of input mechanism. Possible types of input mechanisms include: physical control mechanisms (such as physical buttons, sliders, knobs, keyboards, joysticks, track balls, touch sensitive screen elements, data gloves, etc.), UI control mechanisms (such as graphical buttons, sliders, knobs, etc.), voice activated input mechanisms, and so forth. FIG. 3, to be discussed in turn, provides additional information regarding exemplary mechanisms that allow the recipient-user to perform a commencement action.

FIG. 1 shows one scenario in which the recipient-user receives notification information via the remote media device 104, and then performs a commencement action using the same remote media device 104. Other scenarios are possible. For example, the recipient-user can receive notification information via the remote media device 104, but can then perform the commencement action using some other device, such as remote control device 114. For instance, the remote control device 114 can include a series of physical or UI buttons that allows the recipient-user to perform a commencement action, based on notification information presented by the remote media device 104. In a more concrete example, the recipient-user may be listening to a sample of an album via the remote media device 104, and then issue an instruction to buy the entire album associated with the sample by actuating a button on the remote control device 114. Still further scenarios are possible that can involve yet additional devices. For example, a first remote device can present a sample of a musical piece, a second remote device can present album art, and a third remote device can be used to issue a buy event.

An event is created in response to the recipient-user's commencement action. An event refers to any kind of information which describes the commencement action, and which can be propagated to another device to alert that device to the nature of the action. In one non-limiting example, the event can comprise at least two parts. A first part identifies the object that is the target of the event. For example, if the user seeks to perform some action on a resource, or to purchase the resource, then the object comprises the resource itself. A second part identifies the action to be performed on the object. Exemplary actions mentioned above include: the purchase of the object; the printing of the object; the transfer of the object to an identified recipient; the resizing, cropping, redeye reduction, etc. of the object, and so forth. The different actions can be represented using different respective codes, or by some other technique.

In a third operation (3), the media server 102 receives the event and optionally logs the event in an event store.

In a fourth operation (4), the follow-up user accesses the media server 102 to process any logged events. The follow-up user refers to anyone who completes the transaction initiated by the recipient-user. In one case, the follow-up user is the same as the recipient-user.

In one scenario, the follow-up user is actively engaged with the media server 102 at the time that the event is received. In this case, the media server 102 can immediately notify the follow-up user of the receipt of the event (and, in which case, it may not be necessary to also log the event). In another scenario, however, the follow-up user may not be actively engaged with the media server 102 at the time that the event is received. This may be because the follow-up user is logged off of the computer which implements the media server 102, or because the follow-up user is not engaged in an active session with the media server, e.g., in the case where the computer supports Fast User Switching (FUS), etc. In this scenario, the media server 102 can alert the follow-up user to the existence of any events that have been received during their “absence” (however defined).

The media server 102 can alert the follow-up user to the existence of the events in various ways, such as by providing graphical information, audio information, some combination thereof, and so forth. In one exemplary and non-limiting case, the media server 102 can alert the follow-up user to the existence of the events by providing a graphical bubble message. In any event, the information which the media server 102 imparts to the follow-up user is referred to as “prompting information” herein, to indicate that this information prompts the follow-up user to complete the transaction started by the recipient-user at the remote media device 104.

The media server 102 can be configured to send prompting information to only authorized follow-up users. For example, assume that a parent acts in the role of a recipient-user by flagging certain resources to receive some kind of subsequent processing. These resources may be inappropriate for viewing by all members of the family, or it may be in appropriate for all members of the family to actually complete a financial transaction. Assume that a child of the parent logs onto the media server 102 as a follow-up user. The media server 102 can be configured to determine the identity of this user (e.g., based on the user's password), and determine whether this user is authorized to complete a transaction initiated by the recipient-user parent. This verification operation can be performed by consulting a database to determine whether the particular user is authorized to receive prompting information. In this manner, the media server 102 can prevent the child from receiving the prompting information.

The follow-up user can respond to the prompting information by activating it, e.g., by clicking on the graphical presentation of the prompting information. This can invoke one or more user interface presentations which allow the follow-up user to complete the transaction(s) or at least further advance the transaction. In one case, for example, the media server 102 can invoke one or more user interface presentations which allow the user purchase resources, perform processing on resources, and so forth. These presentations can be hosted by the media server 102 itself or some third party entity, possibly accessible through a wide area network connection, or by some combination of presentations hosted by a combination of the media server 102 and third party entity. For example, the media server 102 can present the follow-up user with a user interface presentation which gives the user the option of advancing with a sales transaction. If the follow-up user invokes this option, then the media server 102 can direct the user to a website hosted by a commercial entity which is selling the resource. In any case, the action taken by the follow-up user in further advancing the transaction that was initiated by the recipient-user is referred to as a “follow-up action” herein. The follow-up action can represent the final step in a transaction, or can represent another non-terminal step in a series of actions that comprise the transaction.

The above description featured the scenario in which the remote media device 104 is a separate device than the media server 102. In particular, the remote media device 104 can represent a thin client, meaning that it has reduced processing resources compared to the media server 102. The approach described above allows a relatively simple remote media device to incorporate more complex services, that is, by using the remote media device to flag transactions to be later completed by the more versatile media server 102. This strategy allows the remote media device to remain simple in design, yet incorporate advanced services.

In another scenario, the four actions (1-4) described above can play out in the context of a single device. For example, a user can log an event using a first device, and then later return to the same device, access the logged event, and complete the transaction based thereon.

Advancing now to FIG. 2, this figure shows a more detailed depiction of the event processing module 110 deployed in the media server 102.

The event processing module 110 includes a number of modules and data stores. To begin with, a notification dissemination module 202 sends notification information to the recipient-user. As previously described, the notification information can comprise any information which can somehow prompt the recipient-user to take an action. For example, the notification information can alert the recipient-user to the existence of a resource, and the recipient-user can perform a commencement action pertaining to that resource. The commencement action generates an event.

An event receiving module 204 receives the event created by the recipient-user. As explained above, the event may have two parts: a first part describes the object of the action; and a second part describes the action itself. The event-receiving module 204 can also optionally log the received event.

An action advancement module 206 allows the follow-up user to further advance a transaction initiated by the recipient-user (again, the follow-up user can represent the same user as the recipient-user). For instance, the advancement module 206 can alert the follow-up user to the existence of one or more logged events. It can perform this task by sending prompting information to the follow-up user. In the case in which the follow-up user happens to be actively engaged with media server 102 at the time that the event is received, then the action advancement module 206 can immediately send the prompting information to the follow-up user; otherwise, the action advancement module 206 can send the follow-up user the prompting information at that time when the follow-up user resumes use of the media server 102 (e.g., by logging back on, resuming an active user session, and so forth).

A registration module 208 allows an administrative user (not shown) to set various operating parameters and other information that governs the operation of the event processing module 110. For example, the registration module 208 can allow the administrative user to set the conditions under which notification information is sent to the recipient-user, conditions under which prompting information is sent to the follow-up user, and so forth.

A content information store 210 stores information that is disseminated to the users, such as notification information sent to the recipient-user, prompting information sent to the follow-up user, and so forth. This store can be implemented by the media server 102 itself, or some other entity (such as a remote website).

A condition information store 212 stores information that governs the operation of the event processing module 110. For example, the condition information store 212 can store conditions under which notification information is sent to the recipient-user, conditions under which prompting information is sent to the follow-up user, and so forth.

Finally, the user action information store 214 can store events received from remote media devices (104, . . . 106). Such events can describe the target objects of the events, as well as the nature of the actions themselves. The user action information store 214 can store events on a user-by-user basis.

FIG. 3 shows an exemplary remote media device 300. This device can optionally include a graphical user interface 302, as well as a collection of physical keys 304. The graphical user interface 302 can be used to display notification information, such as album art. Alternatively, another remote device can be used to present notification information, allowing the remote media device 300 the opportunity to generate an event based on the notification information.

The remote media device 300 can include one or more graphical UI controls (e.g., UI control 306) and/or or more physical controls (e.g., physical button 308) for allowing the user to generate an event. For example, in a purchase scenario, the remote user device 300 can include a buy button (or other kind of control). In a photo browsing scenario, the remote user device 300 can include a print button, a rotate button (to rotate a photo), a redeye removal button (to remove redeye from the photo), and so forth.

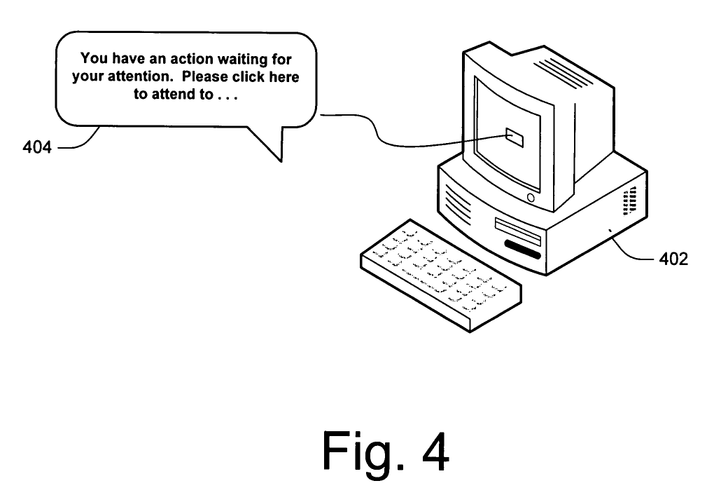

FIG. 4 shows an exemplary mechanism for providing prompting information. In this case, a personal computer 402 implements the media server 102. The personal computer 402 includes a graphical user interface which displays prompting information 404. In this exemplary case, the prompting information 404 takes the form of a graphical bubble message which alerts the follow-up user to the fact that they have events waiting for their attention. It is possible to present the prompting information in many other ways, such as by providing audio information, and so forth.

In one exemplary implementation, the media server 102 can orchestrate the handling of follow-up actions (involving the presentation of prompting information based on queued events) through an automated playback routine (such as AUTOPLAY functionality of WINDOWS, provided by Microsoft corporation of Redmond, Wash.).

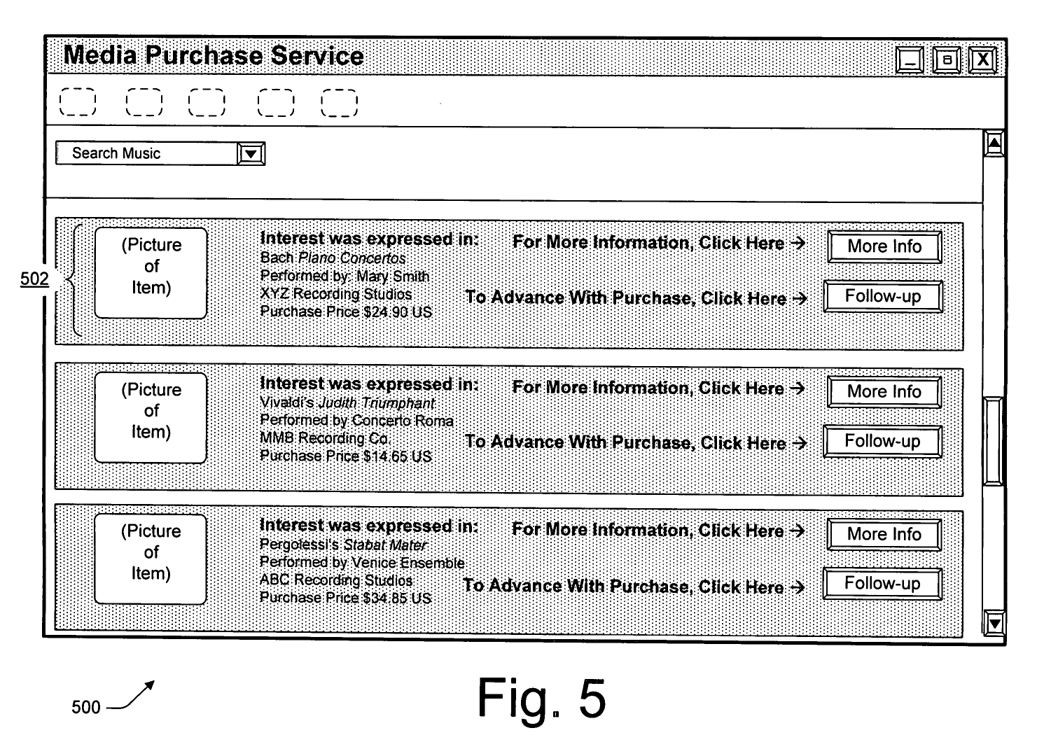

FIG. 5 shows an exemplary user interface presentation 500 that can be invoked when the follow-up user activates the prompting information 404. In this particular scenario, the logged events pertain to purchase events. Thus, in this case, the user interface presentation 500 can list the purchase events and give the user an opportunity to complete these purchase events by actually buying the identified resources (or declining to purchase the resources). For example, entry 502 in the presentation 500 identifies that the recipient-user expressed an interest in buying an album of Bach piano concertos. This entry 502 allows the user to find out additional information regarding this album, or to confirm purchase by actually buying the album. Clicking on any button in the entry 502 can optionally direct the follow-up user to a website which will actually handle the sale of the identified asset. (Or the media server 302 itself can implement UI which orchestrates the sale.)

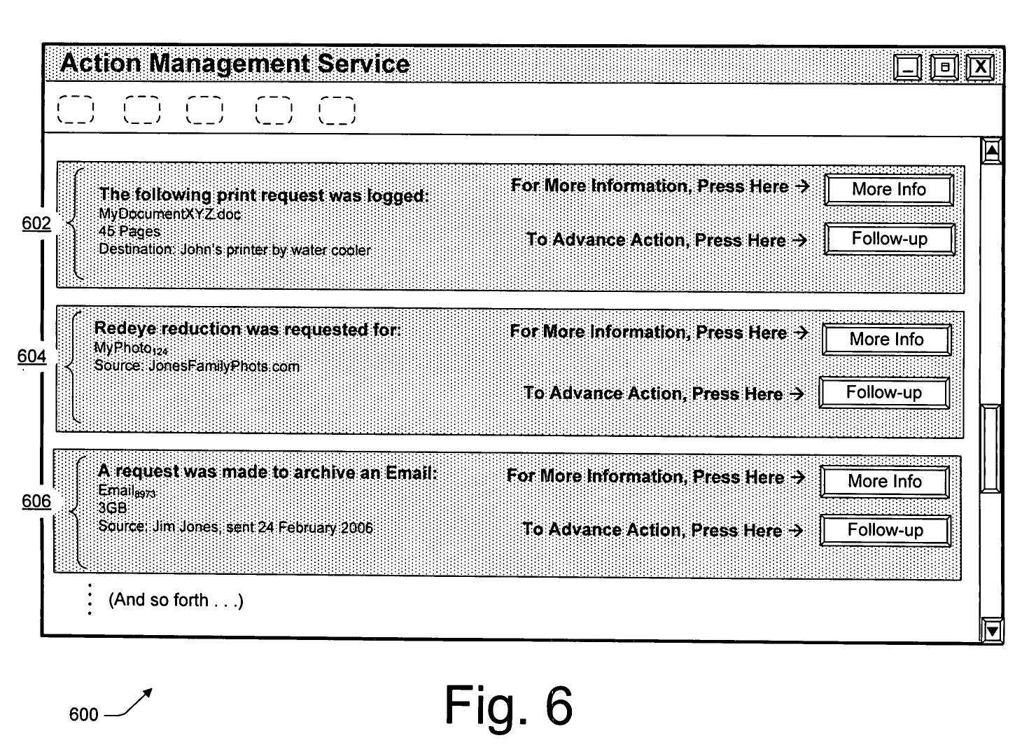

FIG. 6 shows another exemplary user interface presentation 600. This presentation 600 emphasizes that the system 100 can be applied to many kinds of actions. For example, entry 602 gives the follow-up user the option to complete a print operation. Entry 604 gives the follow-up user the option to complete a redeye reduction operation. Entry 606 gives the follow-up user the option to complete an Email handling operation. Those skilled in the art will appreciate that many other operations are possible.

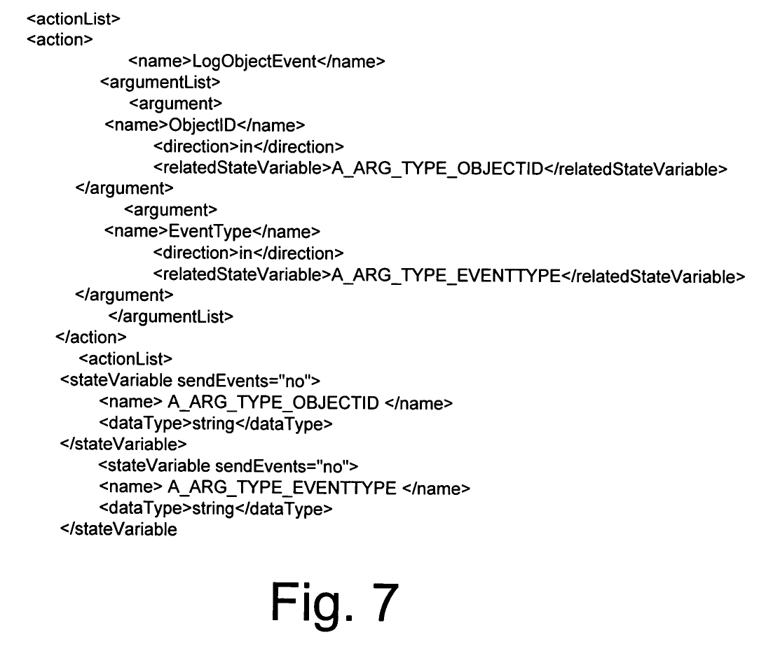

As a final topic of this section, as mentioned above, in one specific implementation, aspects of the system 100 can be implemented using UPnP technology. In this case, FIG. 7 shows an exemplary XML excerpt (LobObjectEvent) that can be used to define the protocol for exchanging event information between the remote media device 104 and the media server 102. The excerpt defines the composition of an event, which includes a first part that identifies the target object of the action (ObjectID), and a second part which identifies the action itself (EventType).

B. Exemplary Processes

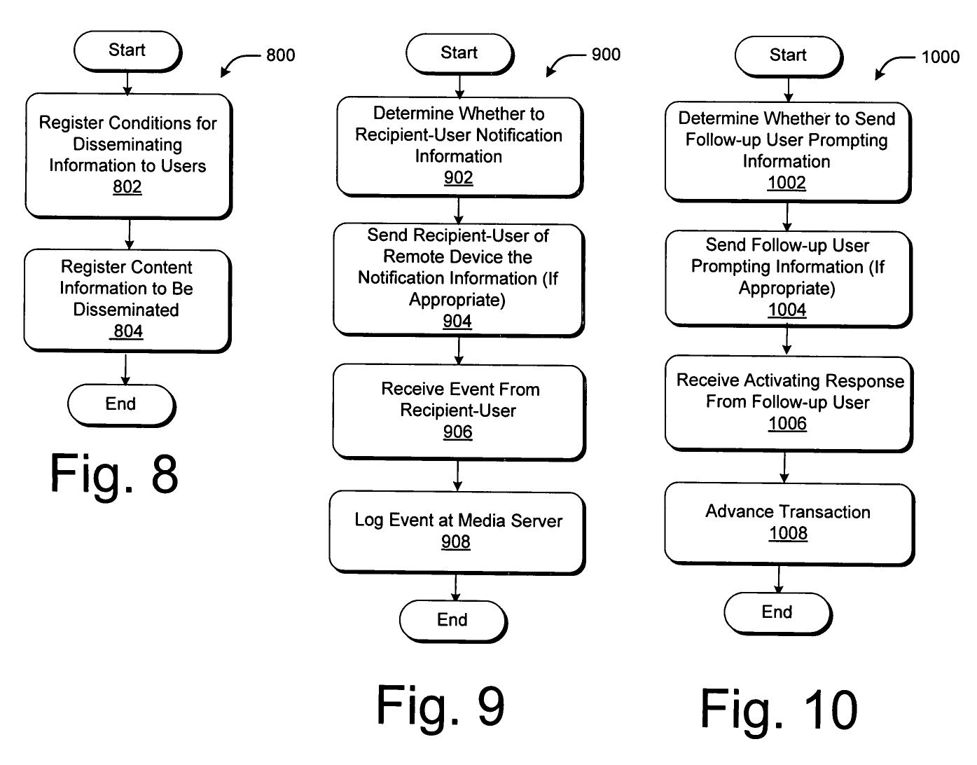

FIGS. 8-10 show procedures (800, 900, 1000) that explain an exemplary manner of operation of the system 100 shown in FIG. 1. To facilitate discussion, certain operations are described as constituting distinct steps performed in a certain order. Such implementations are exemplary and non-limiting. Certain steps described herein can be grouped together and performed in a single operation, and certain steps can be performed in an order that differs from the order employed in the examples set forth in this disclosure. As the operations described in these flowcharts have already been explained in the context of architecture of the system 100, this section will serve primarily as a review of those operations.

FIG. 8 shows a procedure 800 that allows an administrative user to set up various parameters and other information which govern the operation of the system 100. In step 802, the administrative user can set various conditions which govern the dissemination of notification information, prompting information, and so forth. In step 804, the administrative user can register content to be disseminated when the conditions defined in step 802 are met. For example, in step 804, the administrative user can define notification information (e.g., album art), prompting information (e.g., prompting bubble messages), and so forth.

FIG. 9 shows a procedure 900 that describes the solicitation, receipt and logging of an event (from the standpoint of the media sever 102). In step 902, the media server 102 determines whether to send notification information to the remote media device 104. For example, the media server 102 can ensure that only pre-authorized remote media devices receive notification information, or only pre-authorized remote media devices are allowed to respond to the notification information. In step 904, the media server 102 sends the notification information to the remote media device 104. In step 906, the media server 102 receives an event in response to the notification information, indicating that the recipient-user has performed some commencement action in response to the notification information. In step 908, the media server 102 logs the received event in its event store (e.g., the user action information store 214 of FIG. 2).

FIG. 10 shows a procedure 1000 that describes the processing of the logged event. In step 1002, the media server 102 determines whether it is appropriate to send a particular follow-up user the prompting information. Recall that the prompting information alerts to the follow-up user to the existence of the logged event. In step 904, the media server 102 sends the follow-up user prompting information. In step 1006, the media server 102 receives a response from the follow-up user that indicates that the follow-up user has activated the prompting information, e.g., by clicking on a graphical representation of the prompting information. In step 1008, the media server 102 coordinates the advancement of the transaction that was initiated by the recipient-user. This step may involve eventually contacting a site which allows the follow-up user to execute the action, such as by purchasing an identified resource.

C. Other Exemplary Applications

The above discussion featured systems and procedures for handling transactions in a split manner, where part of a transaction is performed with respect to a device which serves a first role, and another part of the transaction is performed with respect to a device which serves a second role. In these applications, the transaction was driven by one or more human users by virtue of their interactions with the devices. The devices were described in the exemplary and non-limiting context of UPnP media rendering devices and media server devices, or any kind of related components.

The principles described herein have additional applications that may vary from the above examples in a number of respects.

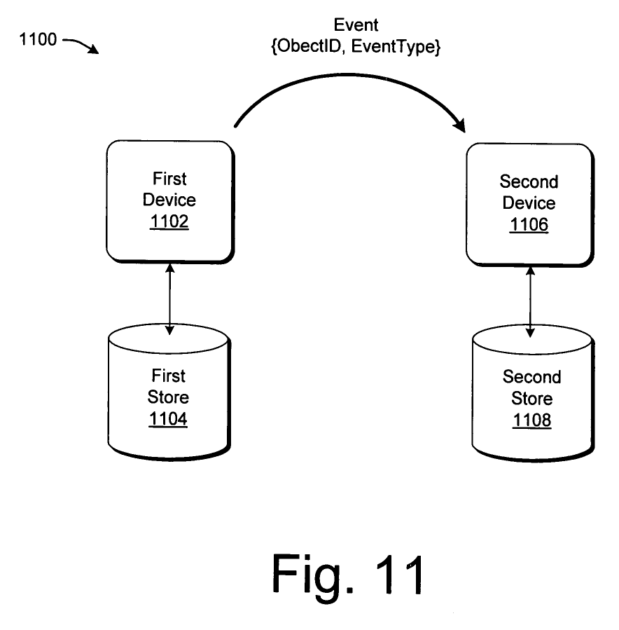

For instance, the terms “transaction,” “commencement action,” and “follow-up action” are to be interpreted broadly herein. Consider the system 1100 of FIG. 11, which achieves resource synchronization (such as file synchronization) between two or more sites. Namely, a first device 1102 can maintain a first set of resources in a first data store 1104, and a second device 1106 can maintain a second set of resource in a second data store 1108. These resources can represent any kind of assets, such as files, etc. At least some resources in the first data store 1104 may represent the same resources stored in the second data store 1108, such that these data stores (1104, 1108) maintain redundant copies of the same resources. The purpose of the resource synchronization operation is to ensure that changes made to the first data store 1104 are duplicated in the counterpart resources contained in the second data store 1108 (and vice versa).

To this end, a change made to a resource in the first data store 1104 can constitute a commencement action that invokes the generation of an event. The event can specify the nature of the resource that is being modified (or perhaps a copy of the resource itself), as well as a description of the change being made to the resource. This event can be sent to the second device 1106 by the first device 1002 in the manner described above. Upon receipt, the second device 1106 can log this event in the manner described above. The second device 1106 can operate on the event immediately upon receipt of the event, or it can act on the event when the follow-up user resumes an active session with the second device 1106. Acting on the event can constitute duplicating the changes made in the first data store 1104 to at least one counterpart resource stored in the second data store 1108.

In the above-described resource synchronization case, note that the “transaction” comprises a transformative act which is performed at the first device 1102 followed by a transformative act which is performed at the second device 1106. Resource synchronization is not limited to two sites (as in FIG. 11). In a more general context, a change made to any device can be duplicated in any number of other devices through the above-described eventing protocol.

More generally, the principles described above can be applied to any context in which a device which serves a first role (e.g., a first device) sends an event to a device which serves a second role (e.g., a second device), which allows the second to act on the event immediately or some time after receiving the event. The first device and the second devices are not limited to media rendering devices and media server devices. Nor are these devices limited to UPnP devices.

Further, the impetus driving the transactions need not represent human user actions. Various actions can be performed in response to automatic triggering events, or at least in part in response to automatic triggering events.

Still additional applications and variations of the above-described principles are possible.

D. Exemplary Computer Environment

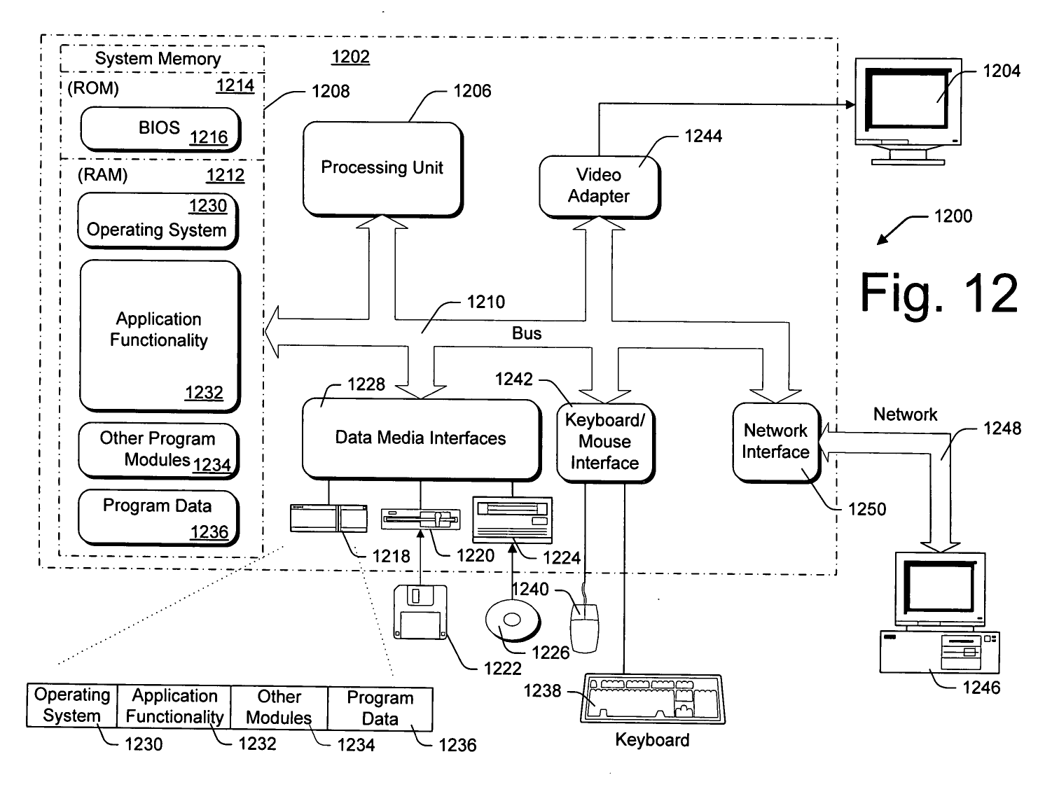

FIG. 12 provides information regarding a computer environment 1200 that can be used to implement any of the processing functions described in the proceeding sections, such as the media server 102. Any of the remote media devices (104, . . . 106) can also incorporate the features described below, or some subset thereof.

The computing environment 1200 includes a general purpose or sever type computer 1202 and a display device 1204. However, the computing environment 1200 can include other kinds of computing equipment. For example, although not shown, the computer environment 1200 can include hand-held or laptop devices, set top boxes, game consoles, mainframe computers, etc. Further, FIG. 12 shows elements of the computer environment 1200 grouped together to facilitate discussion. However, the computing environment 1200 can employ a distributed processing configuration. In a distributed computing environment, computing resources can be physically dispersed throughout the environment.

Exemplary computer 1202 includes one or more processors or processing units 1206, a system memory 1208, and a bus 1210. The bus 1210 connects various system components together. For instance, the bus 1210 connects the processor 1206 to the system memory 1208. The bus 1210 can be implemented using any kind of bus structure or combination of bus structures, including a memory bus or memory controller, a peripheral bus, an accelerated graphics port, and a processor or local bus using any of a variety of bus architectures.

Computer 1202 can also include a variety of computer readable media, including a variety of types of volatile and non-volatile media, each of which can be removable or non-removable. For example, system memory 1208 includes computer readable media in the form of volatile memory, such as random access memory (RAM) 1212, and non-volatile memory, such as read only memory (ROM) 1214. ROM 1214 includes an input/output system (BIOS) 1216 that contains the basic routines that help to transfer information between elements within computer 1202, such as during start-up. RAM 1212 typically contains data and/or program modules in a form that can be quickly accessed by processing unit 1206.

Other kinds of computer storage media include a hard disk drive 1218 for reading from and writing to a non-removable, non-volatile magnetic media, a magnetic disk drive 1220 for reading from and writing to a removable, non-volatile magnetic disk 1222 (e.g., a “floppy disk”), and an optical disk drive 1224 for reading from and/or writing to a removable, non-volatile optical disk 1226 such as a CD-ROM, DVD-ROM, or other optical media. The hard disk drive 1218, magnetic disk drive 1220, and optical disk drive 1224 are each connected to the system bus 1210 by one or more data media interfaces 1228. Alternatively, the hard disk drive 1218, magnetic disk drive 1220, and optical disk drive 1224 can be connected to the system bus 1210 by a SCSI interface (not shown), or other coupling mechanism. Although not shown, the computer 1202 can include other types of computer readable media, such as magnetic cassettes or other magnetic storage devices, flash memory cards, CD-ROM, digital versatile disks (DVD) or other optical storage, electrically erasable programmable read-only memory (EEPROM), etc.

Generally, the above-identified computer readable media provide non-volatile storage of computer readable instructions, data structures, program modules, and other data for use by computer 1202. For instance, the readable media can store the operating system 1230, application-specific functionality 1232 (including functionality for implementing aspects of the event handling module 120 of the media server 102), other program modules 1234, and program data 1236.

The computer environment 1200 can include a variety of input devices. For instance, the computer environment 1200 includes the keyboard 1238 and a pointing device 1240 (e.g., a “mouse”) for entering commands and information into computer 1202. The computer environment 1200 can include other input devices (not illustrated), such as a microphone, joystick, game pad, satellite dish, serial port, scanner, card reading devices, digital or video camera, etc. Input/output interfaces 1242 couple the input devices to the processing unit 1206. More generally, input devices can be coupled to the computer 1202 through any kind of interface and bus structures, such as a parallel port, serial port, game port, universal serial bus (USB) port, etc.

The computer environment 1200 also includes the display device 1204. A video adapter 1244 couples the display device 1204 to the bus 1210. In addition to the display device 1204, the computer environment 1200 can include other output peripheral devices, such as speakers (not shown), a printer (not shown), etc.

Computer 1202 operates in a networked environment using logical connections to one or more remote computers, such as a remote computing device 1246. The remote computing device 1246 can comprise any kind of computer equipment, including a general purpose personal computer, portable computer, a server, etc. Remote computing device 1246 can include all of the features discussed above with respect to computer 1202, or some subset thereof.

Any type of network 1248 can be used to couple the computer 1202 with remote computing device 1246, such as the WAN 402 of FIG. 4, a LAN, etc. The computer 1202 couples to the network 1248 via network interface 1250 (e.g., the interface 416 shown in FIG. 4), which can utilize broadband connectivity, modem connectivity, DSL connectivity, or other connection strategy. Although not illustrated, the computing environment 1200 can provide wireless communication functionality for connecting computer 1202 with remote computing device 1246 (e.g., via modulated radio signals, modulated infrared signals, etc.).

In closing, a number of features were described herein by first identifying exemplary problems that these features can address. This manner of explication does not constitute an admission that others have appreciated and/or articulated the problems in the manner specified herein. Appreciation and articulation of the problems present in the relevant arts are to be understood as part of the present invention. More specifically, there is no admission herein that the features described in the Background section of this disclosure constitute prior art. Further, the description of a limited set of problems in the Background section does not limit the application of the invention to solving only those problems; it can be applied to problems and environments not expressly identified herein. Further, the subject matter set forth in the Summary section and the Abstract of this disclosure do not limit the subject matter set forth in the claims.

More generally, although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

What is claimed is:

1. A method for handling a transaction, comprising:
providing notification information to a recipient-user that pertains to content;
receiving an event that indicates that the recipient-user has performed a commencement action in response to the notification information by activating a control associated with the commencement action, wherein the event describes: a target object associated with the content; and an operation to be performed on the target object;
logging the event to provide a logged event;
informing a follow-up user of the existence of the logged event; and
allowing the follow-up user to perform a follow-up action associated with the logged event, wherein the follow-up action pertains to the content and is associated with the operation identified in the event,
wherein the commencement action and the follow-up action together comprise at least part of the transaction.

2. The method of claim 1, wherein the commencement action comprises a request by the recipient-user to purchase a resource, and the follow-up action comprises an action pertaining to the purchase of the resource.

3. The method of claim 1, wherein the commencement action comprises a request by the recipient-user to perform some processing on a resource, and the follow-up action comprises an action pertaining to the performance of the processing.

4. The method of claim 3, wherein the processing comprises one or more of:
transferring the resource to a target destination;
performing data processing on the resource to transform the data associated with the resource;
altering a status associated with the resource; or
backing up the resource.

5. The method of claim 1, wherein the control is a physical control element associated with the commencement action.

6. The method of claim 1, wherein the control is a graphical user interface element associated with the commencement action.

7. The method of claim 1, wherein a recipient device that the recipient-user uses to receive the notification information is a same device which the recipient-user uses to generate the event.

8. The method of claim 1, wherein a recipient device that the recipient-user uses to receive the notification information is different than a device which the recipient-user uses to generate the event.

9. The method of claim 1, further comprising determining if the recipient-user is pre-authorized to receive the notification information or if the recipient-user is pre-authorized to act on the notification information, and only providing the notification information to the recipient-user if the recipient-user is entitled to receive the notification

10. The method of claim 1, wherein the logging of the event comprises queuing the event in association with the recipient-user who generated the event.

11. The method of claim 1, wherein the recipient-user generates the event by using a device that performs a first role, and wherein the follow-up user performs the follow-up action using a device which performs a second role.

12. The method of claim 11, wherein the device that performs the first role is different than the device that performs the second role.

13. The method of claim 12, wherein the device that performs the first role has fewer processing resources compared to the device that performs the second role.

14. The method of claim 1, wherein the recipient-user is the same as the follow-up user.

15. The method of claim 1, wherein the recipient-user is not the same as the follow-up user.

16. The method of claim 1, wherein the informing of the follow-up user of the logged event comprises automatically sending the follow-up user prompting information through an auto-play routine when it is detected that the follow-up user is engaged in a device which presents the prompting the information.

17. The method of claim 16, further comprises determining if the follow-up user is entitled to consummate the transaction, and only providing the prompting information to the follow-up user if the follow-up user is entitled to receive the prompting information.

18. One or more computer readable media comprising computer readable instructions for performing the method of claim 1.

19. A method for handling a transaction, comprising:
at a first device:
providing notification information to a user that pertains to content;
at a second device:
receiving the notification information;
performing a commencement action associated with the content by invoking a control associated with the commencement action,
wherein the commencement action generates an event that describes: a target object associated with the content; and an operation to be performed on the target object;
at the first device:
receiving the event;
logging the event to provide a logged event;
informing the user of the existence of the logged event; and
allowing the user to perform a follow-up action associated with the logged event, wherein the follow-up action pertains to the content and is associated with the operation identified in the event,
wherein the commencement action and the follow-up action together comprise at least part of the transaction, and
wherein the first device has fewer processing resources compared to the second device.

20. A method for handling a transaction, comprising:
receiving a Universal Plug and Play (UPnP) event that indicates that a first action has been performed with respect to a device that serves a first role;
logging the event to provide a logged event; and
performing a second action associated with the logged event at a device that serves a second role, wherein the second action advances a the transaction that includes the first action as part thereof.
